(19) United States
(12) Patent Application Publication
(10) Pub. No.: US 2025/0121338 A1
(43) Pub. Date: Apr. 17, 2025

(54) APPARATUS AND METHOD FOR FLUID MIXING

(71) Applicant: V-Stax, L.L.C., Charlotte, NC (US)

(72) Inventors: Bruce E. Nadeau, JR., Miami Beach, FL (US); Joseph C. Lull, South Haven, MI (US)

(21) Appl. No.: 18/486,719

(22) Filed: Oct. 13, 2023

(51) Int. Cl. B01F 25/10; B01F 23/451; B01F 25/00; B01F 25/312; B01F 25/431

(52) U.S. Cl. CPC B01F 25/103; B01F 23/451; B01F 25/31241; B01F 25/43171; B01F 25/431971; B01F 25/431972; B01F 2025/913; B01F 2025/917

(57) ABSTRACT

One fluid is mixed into another to provide a high degree of surface contact between the fluids. In operation, the first fluid flows into an aerodynamic perforated vane mixing apparatus in a laminar condition, and is swirled within the mixing apparatus, the second fluid contacts the first fluid, and then the mixture flows through a scalloped device with a regulated venturi expander. A system for mixing one fluid into another and rotatably shearing and homogenizing material is also disclosed. One or more aerodynamic anomalies are employed to provide complete mixing of multiple fluids one or more of which may be a viscous laminar flow fluid. The shearing may be performed by a scissor rotated by a hydraulic, pneumatic, or electric motor. The sheared material may include, for example, paraffin located within crude oil. If desired, the second fluid may be introduced by a multi-physics fluid delivery device.

### BACKGROUND

The present disclosure relates to an apparatus and method for mixing one or more fluids which may be in varying states such as gas, liquid, colloid, or particalized (for example, including nanoparticles). The fluid to which the present disclosure relates may exhibit Newtonian, laminar, or other flow types or conditions. The present disclosure is applicable to a wide range of fluids, including, but not limited to, water, one or more fuels, and one or more solvents. The fluid may include a mixture of fluids of various states and types. According to one embodiment taught herein, at least one fluid is a relatively viscous liquid in a laminar-flow condition, such as, for example, crude oil (an example of a bulk fluid).

The viscous liquid may be transported, if desired, through a fluid delivery system which may include one or more pipes or pipelines. The present disclosure is also applicable to fluid vehicles other than pipes and pipelines. For example, the present disclosure relates to a fluid (which may be a mixture of fluids) flowing through one or more tubes, hoses, or other devices. The configurability and scalability of devices according to the present disclosure allow for application in a wide range of laboratory, industrial, and remote field uses.

As used herein, the word “fluid” means “one or more fluids.” Thus, a “fluid” may be a single fluid, or it may be more than one fluid. If a fluid includes more than one fluid, the fluids may be mixed together. Thus, a “second fluid” may include two or more fluids that are mixed together, and the phrase “first and second fluids” means a first fluid which includes one or more fluids and a second fluid which includes one or more other fluids.

Indian Patent No. 343369 refers to vaned, static devices for swirling/mixing two viscous liquids (paints and polymers) within a pipe. The liquids are coaxially introduced into the pipe upstream from the mixing devices. The second liquid is not introduced into the first liquid anywhere within or adjacent to the mixing devices. In contrast to the devices mentioned in Indian Patent No. 343369, a system constructed in accordance with the present disclosure may include, if desired, one or more concave pockets for forcing or bringing to a restrictive orifice a partially heterogeneous multiple fluid flow to accelerate the flow through an expansion feature on the output side of the concave pocket.

If desired, a system constructed in accordance with the present disclosure may include one or more swirlers stacked with a first swirler. Each swirler may have perforations on the faces of vanes supplied by internal channels which are fed by a circumferential manifold at the outside diameter of the containing tube or pipe. In operation, swirler vanes direct the flow of fluids in a clockwise or anti-clockwise direction into a second swirler having an opposing swirl direction (for instance, if the first swirler has a clockwise flow direction, the next swirler has a counter-clockwise flow direction), and this sequence may continue through the final swirler. Additional swirlers may be successively included with alternating flow directions.

It may be necessary to fold the fluids together multiple times, especially when dealing with highly laminar flow characteristics in viscous fluids, where a high degree of Newtonian flow may be difficult to achieve. If desired, swirlers may be connected to each other by the outer diameter of the tube into which they are fabricated such that the full stream is unobstructed and the vortex folds in full motion without straightening paths. If desired, multiple swirler layers may have perforated surfaces fed by internal channels through a main manifold at the outer diameter of the pipe and a root which can be secured to the inner pipe. The present disclosure should not be limited, however, to the examples described herein, except to the extent such examples are covered by the claims at the end of this specification.

U.S. Pat. No. 8,033,714 (the '714 patent) refers to a stator with vanes for swirling a first fluid, and openings for introducing a second fluid radially into the swirling first fluid, adjacent to the stator. The system is a urea water dosing device for reducing nitrogen oxides (NOₓ) in engine exhaust gas, an exhaust gas recirculation (EGR) device for suctioning exhaust gas into intake air, a combustor in which fuel is mixed into air, or a reformer for mixing air into, and oxidizing, carbon monoxide. The '714 patent does not refer to mixing a fluid into a liquid, and does not use the vanes of the stator to direct flow of the second fluid into the first fluid.

If desired, a system constructed in accordance with the present disclosure may provide a second fluid through a circumferential manifold channel in the outside diameter of a perforated vane assembly unit. The second-fluid supply channels may extend radially inward through the vane intersecting distribution channels extending distally from the supply channels towards the distal end of each vane. Perforations may extend from the distribution channels to the first surface of each vane. The perforations supply a continuous second fluid film to contact a highly-viscous first fluid as it passes through the perforated vane structure. The perforated vane surface provides extremely high surface-contact between the first and second fluids thus ensuring homogeneous mixing of the second fluid with the highly viscous laminar flow of the first fluid.

U.S. Pat. No. 9,879,862 (the '862 patent) refers to an afterburner for a gas turbine engine. According to the patent, trailing edge portions of afterburner vanes can be provided with openings for introducing combustion products into the flow path of the working fluid. The patent also indicates that fuel injection openings can be distributed on the sides of upstream vane portions. Like the '714 patent, the '862 patent does not refer to mixing a fluid into a liquid flowing through a system.

In contrast to the '862 patent, orifices constructed in accordance with the present disclosure may receive a second fluid from a central distribution channel or manifold. The second fluid may be released into a first, viscous fluid stream where the first stream exiting a swirler vane section, folds into itself due to vortex motion imposed by swirler vanes. According to this aspect of the present disclosure, the second fluid is received and folded into the first fluid stream. Again, however, the present disclosure should not be limited by the examples described herein. The subject matter that is claimed is set forth in the claims at the end of this specification.

Disadvantages of the prior art are overcome to a significant extent by the present disclosure. Among other things, methods according to the present disclosure may have reduced energy requirements for mixing, reduced system entropy, a modular design to facilitate automated assembly, and reduced maintenance requirements.

### SUMMARY

The present disclosure relates to a fluid-mixing apparatus and method which introduces a variable amount of one or more fluids into a first fluid. To meet resource conservation and economic constraints, the amount of the second fluid may be precisely regulated and limited to the most efficient amount necessary to achieve the desired effect upon the first fluid. Therefore, if desired, the second fluid may be precisely metered into the first fluid while a high degree of surface contact is achieved.

The fluids may subsequently be swirled or the flow modified to work the mixture to promote homogeneity (thorough mixing) of the two fluids. The first fluid may be a relatively viscous liquid in a laminar-flow condition, such as, for example, crude oil transported by the system. The second fluid may be introduced immediately downstream of a swirler, through radially-outward-extending tubes, or through openings built into the swirler vanes, and a scalloped, dish-shaped device may be downstream from the swirler, where the liquid mixture flows through venturi holes.

According to one aspect of the present disclosure, the cross sectional area of each component of the system is equal to the cross sectional area of the first fluid channel or pipe plus an additional flow area factor determined by fluid dynamics, numerical methods, or simulation to be an ideal and efficient cross section to allow flow of the first fluid without a change in flow rate, friction, or pressure drop.

If desired, a system constructed in accordance with the present disclosure may have a perforated vane which operates according to aero/fluid dynamic principles. According to this aspect of the present disclosure, one or more perforated vane modules may have airfoil shapes typical of an aircraft wing. Features such as surface undulations or serrations especially on the leading and/or trailing edges of such vanes may be used to enhance flow anomalies to improve fluid mixing.

Thus, unlike prior-art swirlers for mixing and flow enhancement, swirlers constructed in accordance with the present disclosure may have airfoil configurations with aerodynamic geometries and surfaces tuned to the natural frequencies of the fluid or fluids to be homogenized. The swirlers may achieve full interactive surface contact and optimized mixing whereby flow anomalies inherent in airfoils are exploited and, in some configurations, amplified to improve mixing.

If desired, numerical methods may be utilized to tune the desired geometry and achieve optimized flow dynamics for mixing. These aero- or fluid-dynamic features may amplify flow anomalies normally encountered in airfoil and flow designs to induce multiple vortices. Leading and trailing edges or vane surfaces may include undulations or serrations or other geometries to amplify flow anomalies.

The present disclosure also relates to a method of mixing a second fluid into a first fluid with a high degree of surface contact between the fluids, wherein the first fluid is a liquid, and wherein the method includes: flowing the first fluid into one or more fluid distributions in a mixing apparatus in a laminar condition; swirling the first fluid within the mixing apparatus; causing the second fluid to contact the first fluid; and subsequently, causing a mixture of the fluids to flow through a residence area where first mixing actions are largely completed and a first level of homogeneity is achieved. The combined flow then enters a scalloped, parabolic dish-shaped device where the combined flow is focused and expanded through a plurality of parallel venturi features. Focused flow streams exiting the venturis expand into each other to facilitate further mixing, and recursion mixing of part of the combined flow occurs inside the cone of the exiting stream.

According to another aspect of the present disclosure, a second fluid is provided through a circumferential manifold channel in the outside diameter of a perforated vane assembly unit. Second fluid supply channels extend radially inward through the vane and intersect distribution channels extending distally from the supply channels towards the distal end of each vane. Perforations extend from the distribution channels to the first surface of each vane.

Such perforations may be used supply a continuous second fluid film to contact the first fluid as it passes through the perforated vane structure. The perforated vane surface provides extremely high surface contact between the first and second fluids thus ensuring homogeneous mixing of the second fluid with the highly viscous laminar flow of the first fluid. As noted, however, the present disclosure should not be limited to these examples except to the extent the examples are covered by the claims.

In traditional applications for viscous, laminar fluids, relatively rigid and tortuous flow paths may be required to force separate streams to interact, achieve a high surface contact ratio, reduce heterogeneity, and impress homogeneity (thorough or complete mixing) for various process purposes. The present disclosure recognizes that such rigid and tortuous flow paths present inefficiencies through restrictions, pressure drops, and increased friction to force and impose contact between multiple fluids. The present disclosure can overcome these disadvantages and achieve high surface area contact of multiple fluids, and homogeneous mixing, by presenting the second fluid to the first fluid with extremely high surface contact. By achieving such high surface contact at the point of second fluid distribution, the desired effects can be achieved by less aggressive, lower entropy, or lower energy consuming mixing while maintaining the natural flow rate and pressure of the first fluid.

The present disclosure also relates to an apparatus for mixing a second fluid into a first fluid with a high degree of surface contact between the first and second fluids, wherein the first fluid is a liquid, and wherein the apparatus includes: a mixing apparatus; an inlet for flowing the first fluid into the mixing apparatus in a laminar condition; and a swirling device. If desired, the swirling device has a plurality of vanes for swirling the first fluid within the mixing apparatus. Each vane may have an airfoil configuration to induce pressure differentials and turbulent eddies across the vane edges.

Further, the apparatus may include flow passages within the swirling device for causing the second fluid to come into contact with the first fluid, and a scalloped, parabolic dish-shaped device in which the combined flow is expanded through a plurality of parallel venturi features. Focused flow streams exiting the venturi features expand into each other while a recursion mixing of part of the combined flow occurs inside the cone of the stream exiting the venturi feature such that the fluids are further mixed.

Certain liquids pose unique mixing challenges due to their sometimes highly laminar flow characteristics. An objective of the present disclosure is to entrain a second fluid stream into a first primary fluid stream to obtain a uniform or homogeneous mixture, and obtain a significantly reduced residence time to homogeneity (thorough or complete mixing), with a target of near-zero residence time, eliminate entropy, and with reduced energy input. The second fluid may include small particles, or it may be a full contact thin film.

According to one aspect of the present disclosure, a containment vessel, pipe, or flanged insert directs the product flow through the process. An apparatus constructed in accordance with the present disclosure may be scalable and configurable for a range of pipe diameters, fluid viscosities, and flow rates. If desired, components of the system may have a modular construction to facilitate machine assembly and ease of maintence. Each element of the system may be inserted from either the proximal or distal end of the containment vessel so as to be stacked on one another to form a sequential processing unit. A processor constructed in accordance with the present disclosure may include modified-airfoil vortex-inducing swirler-vanes, a residence zone, or one or more residence elements, a reaction or mixing chamber, and a flow modifier processor element. The processor element may have one or more pressure and velocity flow modifiers whose geometry and function are that of a de Laval, a venturi, or another suitable fluid dynamics modifier.

The second fluid (which is mixed into the first fluid) may be an inoculant, reactant, or other modifier. The second fluid may be one or more fluids of various viscosities and states. The second fluid may be in a gaseous or liquid state, and may be an additive, modifier, inoculant, or reactant to the first, viscous fluid. The second fluid may be a micro or nanoparticle solid which can be transported in suspension in a medium as a colloid, nanoparticle fluid, or another suitable method.

As noted above, the word “fluid” means herein “one or more fluids.” Thus, the second fluid may include two or more fluids that are mixed into the first fluid, if desired. Likewise, the first fluid, which may be a viscous liquid, may be a mixture of more than one fluid. If desired, precise metering and distribution of the fluids may be employed to ensure efficient and economical volumes of fluids for minimum resource usage with maximum mixing and reaction benefit. As noted previously, however, the present disclosure should not be limited to the examples described herein except to the extent such examples are covered by the claims.

If desired, the delivery channels for introducing the second fluid into the first fluid may be attached, overlayed, or built into the swirler vanes during a fabrication process such as a lost-wax process, three-dimensional (3D) printing, or another suitable process. According to another aspect of the present disclosure, the delivery channels may be located within an airfoil-shaped vane. The delivery channels may terminate at the leading or trailing edges of vortex inducing swirler-vanes. A thin film along such edges may have high surface area contact with the first fluid passing across the edges. In operation, flow can be managed to utilize aerodynamic anomalies to induce folding and recursion in and around the swirler vanes.

According to this aspect of the present disclosure, it is possible to take advantage of what in other contexts may be considered airfoil anomalies and natural inefficiencies, and the leading and trailing edge anomalies may be used advantageously for mixing. Thus, an apparatus constructed in accordance with the present disclosure may have one or more airfoils and modified air flow dynamic vortex inducing swirler-vanes. Perforated channels (or tubes) may be integrated into the leading or trailing edges of the vanes. The perforated channels may be a delivery source for the second fluid.

If desired, the mixing of the second fluid into the first fluid may occur where the first, viscous fluid exits the aerodynamic swirler vanes and experiences aerodynamic anomalies to induce folding and recursion in and around the swirler vanes. In operation, the mixed fluids fold into themselves due to the imposed vortex motion provided by the swirler vanes. The second fluid is preferably received and folded into the first fluid at or near an exit region defined by the swirler vanes.

If desired, a residence, reaction, or mixing chamber may be located between the vortex inducing swirler-vanes and the flow modifier processor element. The residence chamber length and diameter may be sized, employing numerical methods, to the flow characteristics and natural frequencies of the working fluids such that induced flow motions are expended and homogeneity is optimized.

If desired, the mixing apparatus may be configured as a single unit which can be flipped as a unit, or reversed, within the system, to situate the vortex inducing swirler-vanes at either an upstream end or a downstream end relative to the direction of flow within the system.

According to another embodiment of the present disclosure, the vortex inducing swirler-vanes have a channel or channels internal to the vanes from just under the surface of the leading edges and terminating prior to opening on the trailing edges of the vanes. The channels may have small holes to form perforated first vane surfaces. According to this embodiment, the perforated surfaces of the vanes may be the delivery source for the second fluid.

According to yet another embodiment, the vortex-inducing swirler-vanes have a cellular or porous construction (for example, partially of metal foam). The first surface of each vane may be porous while the second surfaces of the vanes are closed and smooth. Channels may be constructed within the vanes. If desired, the channels feature the porous surface throughout their length. The function of the cellular (metal foam) construction is to facilitate a broad distribution of the second fluid, as it is not restricted to an array of small holes feeding the first vane surfaces.

If desired, the elements of the mixing apparatus, including the vortex-inducing swirler-vanes, may be fabricated according to standard machining methods. For example, the tubes, channels, and separators (perforated and/or solid) may be individually fabricated and then joined or assembled by one or more joining or fusing methods.

The apparatus preferably has one or more residence/mixing elements or a zone in which the first and second fluids interact with each other. The residence/mixing elements or zone may be located between the swirler-vanes and the flow modifier processor element. In other words, the residence/mixing elements/zone may be located downstream of the channel openings which introduce the second fluid into the first fluid and upstream from the flow modifier processor element which further mixes the first and second fluids.

Another embodiment of the flow modifier processor element has vortex inducing swirler vanes in a concave entry feature serving to further swirl and mix the first and second fluids and thereby create more contact between the fluids. In operation, the first, viscous fluid, in a laminar-flow condition, is pumped or forced onto the upstream sides of the vortex inducing swirler-vanes. A thin film of the second fluid, which may be an inoculant, is formed on the contact surfaces (the first surfaces contacted by the first fluid) of the swirler vanes. The first fluid is forced across the thin film of the second fluid so that the second fluid makes full interfacial contact with the first fluid, and the swirling configuration of the swirler vanes causes the second fluid to be entrained into the first fluid.

If desired, a multi-physics fluid atomizer of the type described in U.S. Pat. No. 10,883,454 (the '454 patent) may be employed in an apparatus according to the present disclosure. In such an apparatus, the fluid atomizer receives one or more fluids and creates a plume of finely atomized particles or droplets. The plume is arranged such that the cross section of the plume is evenly distributed across the entry of the first swirler or shearing device (in the case of a motorized shear-homogenizer). The small particles, having a high surface area to volume ratio, are released in a quantity and distribution such as to achieve maximum contact with the first fluid. Subsequent mixing stages may be used to ensure full homogeneity.

If desired, a shear-homogenizer may be used to input a second fluid toward the head of a rotor and stator. The first fluid may be input by a fluid atomizer described in the '454 patent. If desired, two or more fluids produce small droplets or particles dispersed in a homogeneous plume at a plume angle that covers the diameter of the rotor/stator assembly. In another embodiment, a perforated vane device is situated ahead of the shear rotor/stator assembly whereby the perforated vane device introduces a second fluid thin film into the first fluid flow and is directed into the rotor/stator shear homogenizer.

A shear-homogenizer constructed in accordance with the present disclosure may utilize a machine-driven rotor and a stator. The rotational speed of the machine may be variably controlled to produce a segment of the fluid flow having a duration or length desired for a specific process result. For example, according to one example, paraffins too large for processing are embedded in the first fluid flow. Such paraffins can be reduced to a practical size (or length) by variably setting the rotational speed of the rotor/stator to the first fluid flow rate and thereby shearing the paraffins to a desired length for further processing.

Structures in accordance with the present disclosure may be configured to manage first and second fluid flows to: a) bring them together into a folding viscous laminar dynamic vortex flow to engage high surface contact between the two fluids, and b) create first and second viscous laminar fluid flows managed into a dynamic and progressive toroidal flow to engage high surface contact between the fluids.

Further, the present disclosure relates to an apparatus and method for mixing a second fluid into a first fluid with a high degree of surface contact between the first and second fluids, wherein the first fluid is a liquid, and wherein the method includes: flowing the first fluid into a mixing apparatus in a laminar condition; causing the second fluid to contact the first fluid; and subsequently, rotatably shearing material within a mixture of the first and second fluids. If desired, the material that is rotatably sheared includes paraffin located within crude oil flowing through the system.

A shear-homogenizer constructed in accordance with the present disclosure may input a second fluid toward the head of the rotor and stator. The first fluid may be input by a multi-physics fluid atomizer described in U.S. Pat. No. 11,674,479. The fluid atomizer may convert two or more fluids into small droplets or particles dispersed in a homogeneous plume at a plume angle that covers the diameter of the rotor/stator assembly. In another embodiment, a perforated vane device may be situated ahead of the shear rotor/stator assembly such that the perforated vane device introduces a second fluid thin film into the first fluid flow and is directed into the rotor/stator shear homogenizer.

The shear-homogenizer of this example may have a machine driven rotor and stator, and the rotational speed of the machine may be variably controlled to produce a segment of the fluid flow with a duration or length desired for a specific process result. For example, in one embodiment, paraffins too large for processing are embedded in the first fluid flow. These paraffins can be reduced to a practical size (or length) by variably setting the rotational speed of the rotor/stator to the first fluid flow rate thus shearing the paraffins to a desired length for further processing.

### BRIEF DESCRIPTION OF DRAWINGS

FIG. 1 is a side view of an example of a system for transporting a first fluid, where the system has a mixing apparatus aligned between two portions thereof;

FIG. 2 is a partial cross-sectional view of the mixing apparatus of FIG. 1, showing examples of vortex inducing swirler-vanes and flow conduits for introducing a second fluid into the first fluid, a mixing element, a mixing and residence chamber (described in more detail below), and a flow modifier processor element all located within the mixing apparatus housing;

FIGS. 3, 4, and 5 are a side view and front and back perspective views, respectively, of the swirler vanes and flow conduits of FIG. 2;

FIGS. 6, 7, and 8 are a side view and front and back perspective views, respectively, of another configuration of swirler vanes and flow conduits, incorporating a perforated vane module (described in more detail below), for use within the mixing apparatus of FIGS. 1 and 2;

FIGS. 9 and 10 are front and back perspective views, respectively, of yet another configuration of swirler vanes and flow conduits, incorporating the perforated vane module, for use within the mixing apparatus of FIGS. 1 and 2;

FIG. 11 is a cross-sectional view of a perforated vane for the configuration illustrated in FIGS. 9 and 10, where the cross-sectional plane is parallel to, and between, the front and back surfaces of the vane;

FIG. 12 shows an example of an intermediate swirler plate constructed in accordance with the present disclosure;

FIGS. 13 and 14 are a front perspective view and a side view, respectively, of the flow modifier processor element of FIG. 2;

FIGS. 15 and 16 are a front perspective view and a side view, respectively, of another flow modifier processor element for use in the mixing apparatus of FIGS. 1 and 2;

FIGS. 17 and 18 are partial cross-sectional views of examples of systems which contain apparatuses for mixing, shearing, and homogenizing first and second fluids;

FIG. 19 is a schematic, cross sectional view of swirling vanes which have airfoil (or hydrofoil) configurations;

FIG. 20 is a schematic view show the operation of a venturi regulator;

FIG. 21 is a front, perspective view of a flow modifier processor element with upstream swirler elements; and

FIG. 22 is a front, perspective view of a coaxial mixer for use in the mixing, shearing, and homogenizing systems of FIGS. 17 and 18.

### DETAILED DESCRIPTION

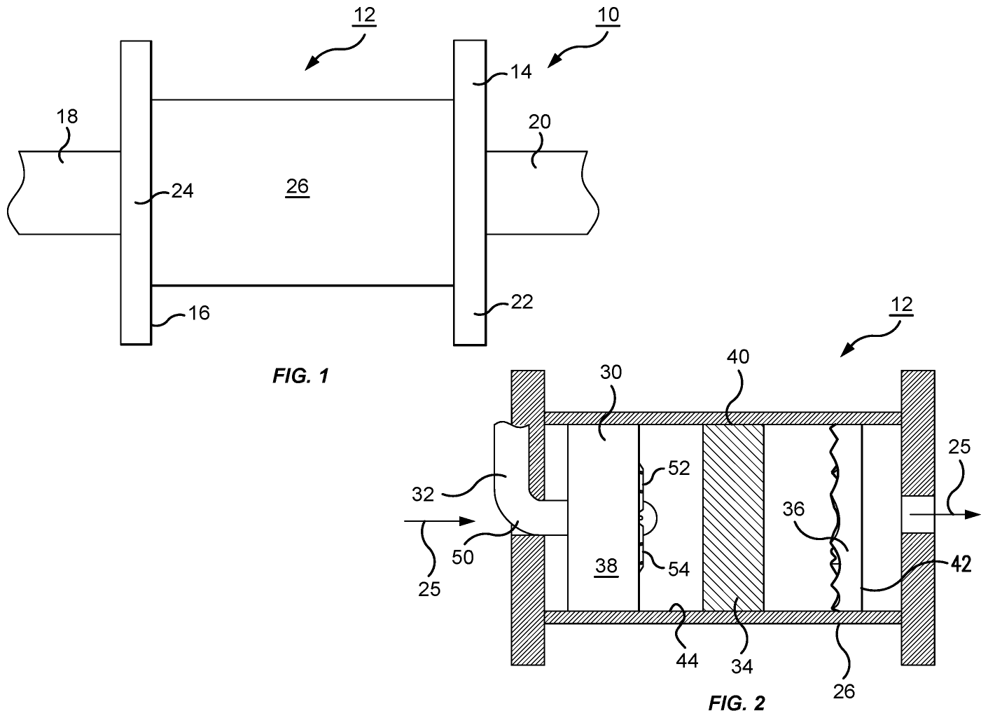

Referring now to the drawings, where like reference numerals designate like elements, there is shown in FIG. 1 a system 10 constructed in accordance with the present disclosure. The system 10 may include, for example, a pipeline, one or more pipes, one or more tubes, or one or more other suitable devices. A mixing apparatus 12 is located within the system 10. Opposite ends 14, 16 of the mixing apparatus 12 are connected to upstream and downstream portions 18, 20 of the system 10 by flanges 22, 24 or other suitable connecting devices. A first fluid (not shown in FIG. 1) flows through the system 10 from left to right as viewed in FIG. 1.

The mixing apparatus 12 may be in the form of a containment vessel, a pipe, or a flanged insert. The system 10 and the mixing apparatus 12 are cylindrical in the illustrated embodiment but may have some other suitable configuration. The interior diameter of the illustrated mixing apparatus 12 is preferably greater than the interior diameter of the pipeline main portions 18, 20, as discussed in more detail below. The interior diameter of the pipeline main portions 18, 20 may be on the order of two inches (or another suitable dimension). The present disclosure should not be limited to the examples described herein.

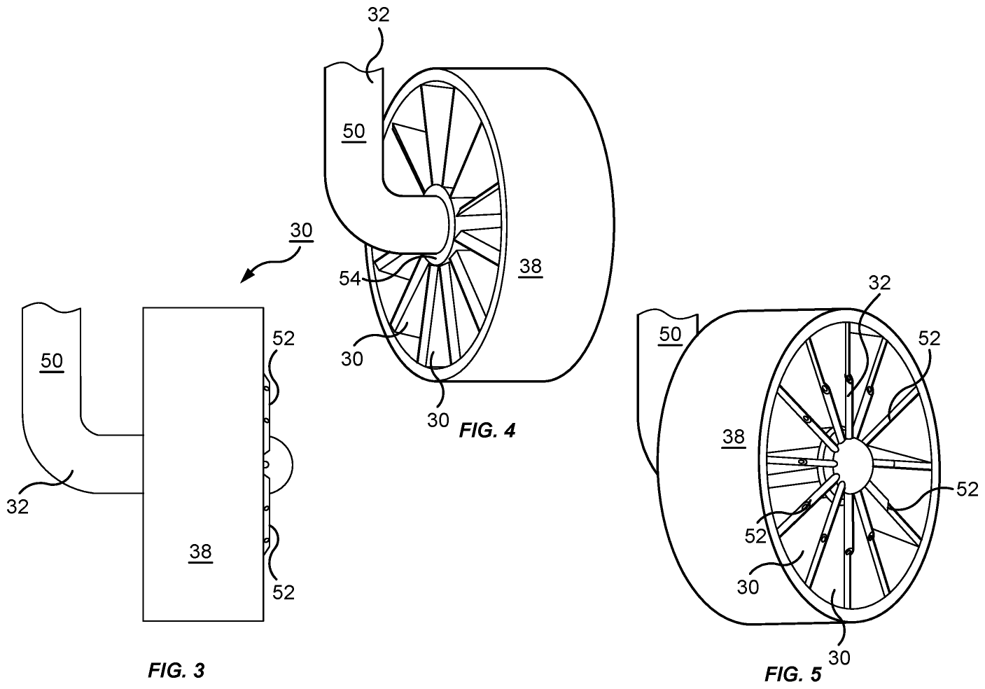

As illustrated in FIG. 2, the mixing apparatus 12 has an assembly of vortex inducing swirler vanes 30, channels 32 for introducing the second fluid (not shown), a residence/mixing element or zone 34 (schematically illustrated in FIG. 2), and a flow modifier processor element 36. Three of these elements 30, 34, 36 within the mixing apparatus 12 have cylindrical outer surfaces 38, 40, 42 which mate within the inner cylindrical surface 44 of the mixing apparatus housing 26.

If desired, the internal surface 44 of the housing 26 may include surface geometries such as topography-driven Langmuir circulation to induce longitudinal streams of vortices. These longitudinal geometries may be further modified to be spiral through a portion of the length of the housing 26 to induce a progressive toroidal flow and further enhance homogenization. Surface geometries which may be employed in combination with other features of the present disclosure are described in Ellingsen et al., Designing vortices in pipe flow with topography-driven Langmuir circulation, Journal of Fluid Mechanics, Vol. 926 (Sep. 6, 2021) (Ellingsen et al.). The entire disclosure of Ellingsen et al. is incorporated herein by reference.

If desired, the elements 30, 34, 36 of the mixing apparatus 12 may be configured for ease of automated assembly and quick-change field maintenance. The illustrated elements 30, 34, 36 may have modular configurations so that they can be assembled into the apparatus 12 by being dropped in from either the input or output (proximal to distal) ends of the apparatus 12.

As illustrated in FIG. 2, the apparatus 12 may have a mixing and residence chamber 34 where first and second fluids use up the turbulent energy of the second fluid introduction and swirler module 30. As the fluids return to a laminar flow state in the residence chamber 34, the second fluid continues to interact with the first fluid. As the fluid flow straightens, it immediately contacts the flow modifier module 36 where it is subjected to expansion forces imparting further turbulence and mixing. If desired, the residence chamber 34 may also include a swirl inducing module (discussed below) to impart additional turbulence to the laminar fluids.

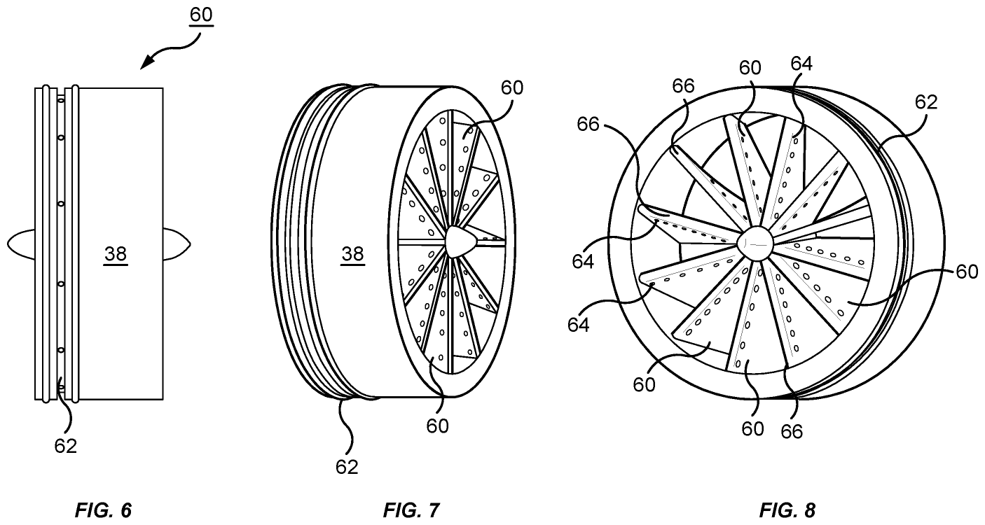

Turning now to FIGS. 3-4, the channels 32 include a second-fluid input channel 50 for bringing (dosing) the second fluid into the mixing apparatus 12 (FIG. 2) from a device (not shown in FIGS. 3-5) outside of the mixing apparatus 12. The vanes 30 are inclined relative to the flow axis 25 through the cylindrical housing 26 to create a swirling motion in the first fluid as the first fluid travels from left to right as shown in FIG. 3.

In the illustrated apparatus 12, two or more fluids, one of which may be highly laminar and viscous, are introduced to each other such that high surface contact is made between the fluids at the point of introduction and at the point where the fluids are immediately imparted with a joining fluid pressure and induced turbulence. In the illustrated apparatus 12, homogeneous mixing may occur immediately at the point of introduction of the multiple fluids.

The channels 32 may include radially directed single-hole tubes 52 (FIG. 5) located on the trailing edges of the vanes 30 for introducing the second fluid into the first fluid. According to one aspect of the present disclosure, fluid pressure and induced turbulence are imparted immediately upon introduction of the second fluid. The input channel 50 is connected to radially inner ends of the single hole tubes 52 through a central portion 54 (FIG. 4) of the vanes 30. In operation, the first fluid flows into the vanes 30 in a laminar condition, the second fluid flows from outside the mixing apparatus 12, though the input channel 50, through the central portion 54, and radially outward though the open ends of the tubes 52, where the second fluid is mixed into the swirling first fluid.

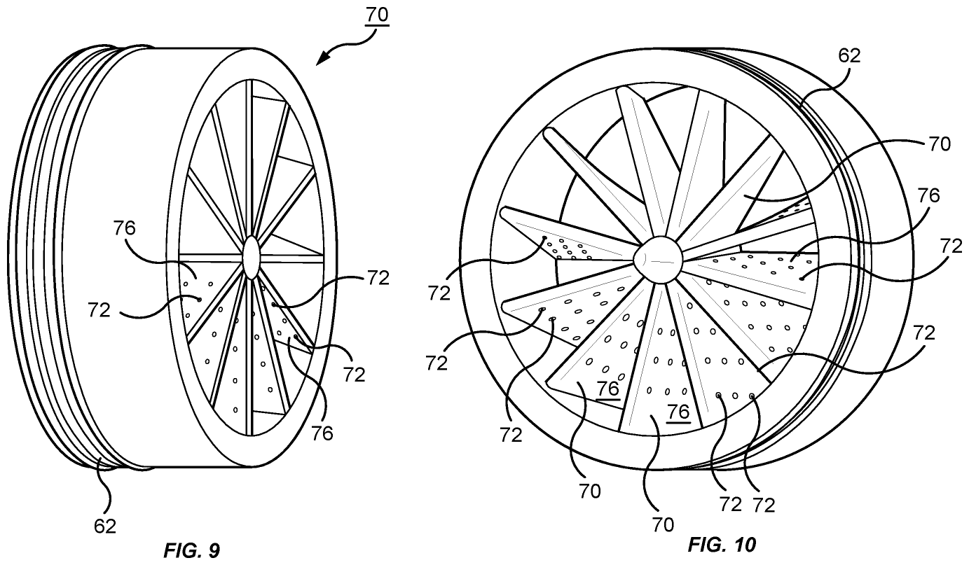

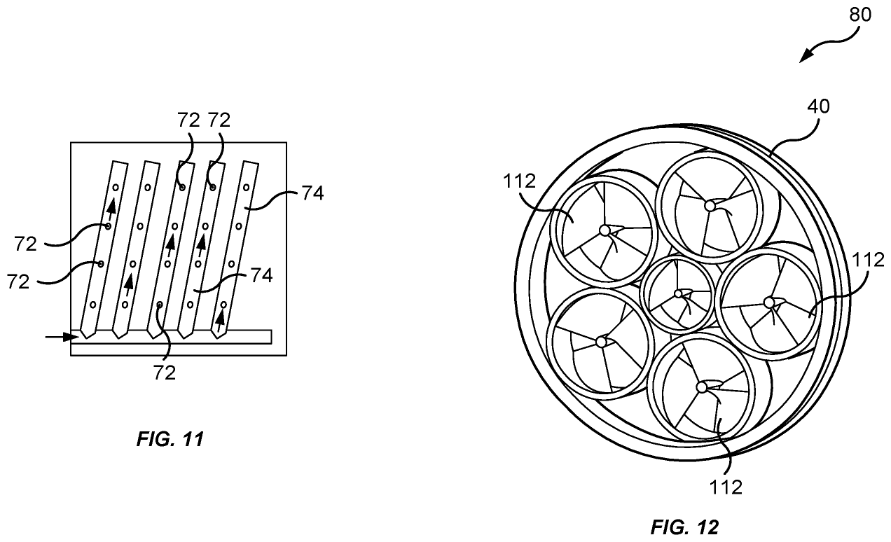

In another embodiment, illustrated in FIGS. 6-8, another assembly of vanes 60 may be used in place of the vanes 30 shown in FIGS. 2-5. In the FIGS. 6-8 embodiment, the second fluid enters the assembly of vanes 60 through an input manifold (or annular channel) 62, and exits the vanes 60 at output openings 64 located on the trailing edges 66 of the vanes 60. In the configuration illustrated in FIGS. 6-8, the first fluid, flowing in a laminar condition, travels through the assembly of vanes 60 from right to left as viewed in FIG. 7, while the second fluid flows within channels (not shown) inside the vanes 60 and comes into contact with the swirling first fluid as the second fluid exits the trailing edges 66 through the openings 64.

In the illustrated embodiment, the second fluid exits the vanes 60 through the output openings 64 on the trailing edges 66 of the vanes 60. If desired, however, whether the second fluid exits the leading or trailing edges of the vanes depends on the desired application. Numerical methods of fluid dynamics may be used to determine the desired position and placement for efficient and efficacious introduction of the second fluid using the first fluid flow energy to initiate and perform the mixing process without parasitic losses. As noted above, the term “second fluid” includes one or more fluids.

In the illustrated embodiment, the input manifold 62 extends all the way around the corresponding assembly of vanes. If desired, however, there may be multiple manifolds each of which extends only partially around the assembly of vanes in a “half moon” configuration. Alternatively, when the second fluid includes multiple fluids, every other vane may be fed one of such multiple fluids through a separate manifold channel.

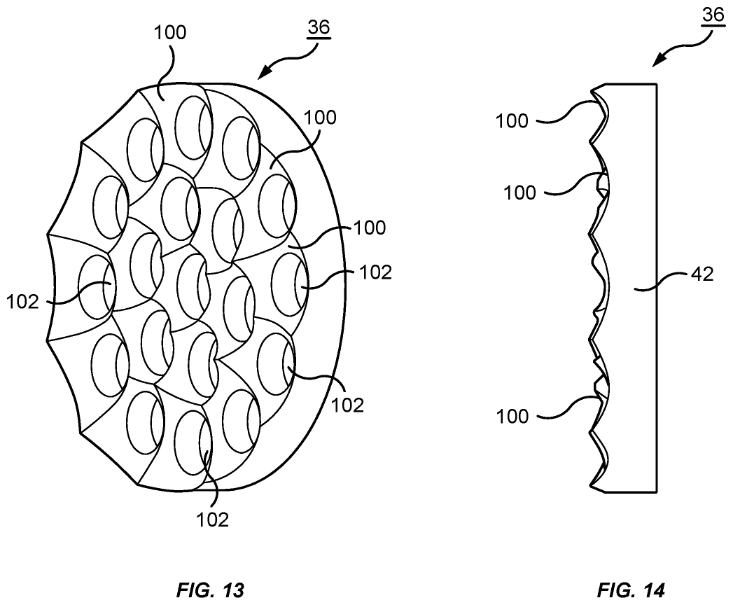

Turning now to FIGS. 9 and 10, yet another assembly of vanes 70 may be used in place of the vanes 30 shown in FIGS. 2-5. In the FIGS. 9 and 10 embodiment, the second fluid enters the assembly of vanes 70 through an input manifold (or annular channel) 62, and exits the vanes 70 at output openings 72 on the upstream faces of the vanes 70. In the configuration illustrated in FIGS. 9 and 10, the first fluid, reaching the assembly of vanes 70 as a liquid in a laminar-flow condition, travels through the assembly of vanes 70 from right to left as viewed in FIG. 9, while the second fluid flows within channels 74 (FIG. 11) interior of the vanes 70 and exits through the openings 72.

Thus, the second fluid forms thin films on upstream surfaces 76 of the vanes 70. The thin films make contact with the swirling first fluid as the first fluid is swirled by the upstream vane surfaces 76. As illustrated in FIG. 11, the openings 72 are spaced apart from each other and aligned diagonally such that each opening 72 is aligned with a different line of flow of the first fluid across the upstream vane surfaces 76.

If desired, there may be a plurality of perforations 72 for each fixed vane oriented in a columnar angle such that no one perforation overlaps another. Such an orientation may usefully cause the second fluid to form a thin film across the first fluid impact face of each vane. Forming the second fluid into a thin film in this way makes it possible to provide a metered amount of the second fluid into the first fluid, to promote the desired amount of homogeneous mixing of the first and second fluids. The manner in which the openings (or perforations) 72 are diagonally arrayed on the vanes 70 improves the distribution of the second fluid into the first fluid.

If desired, an intermediate swirler plate 80 (FIG. 12) may be located within the residence or mixing elements or zone 34 (FIG. 2), between the assembly of swirler vanes 30, 60, or 70 and the desired flow modifier processor element 36. The intermediate swirler plate 80 has additional swirler vanes 112 for further swirling of the first fluid, and mixing of the second fluid into the first fluid.

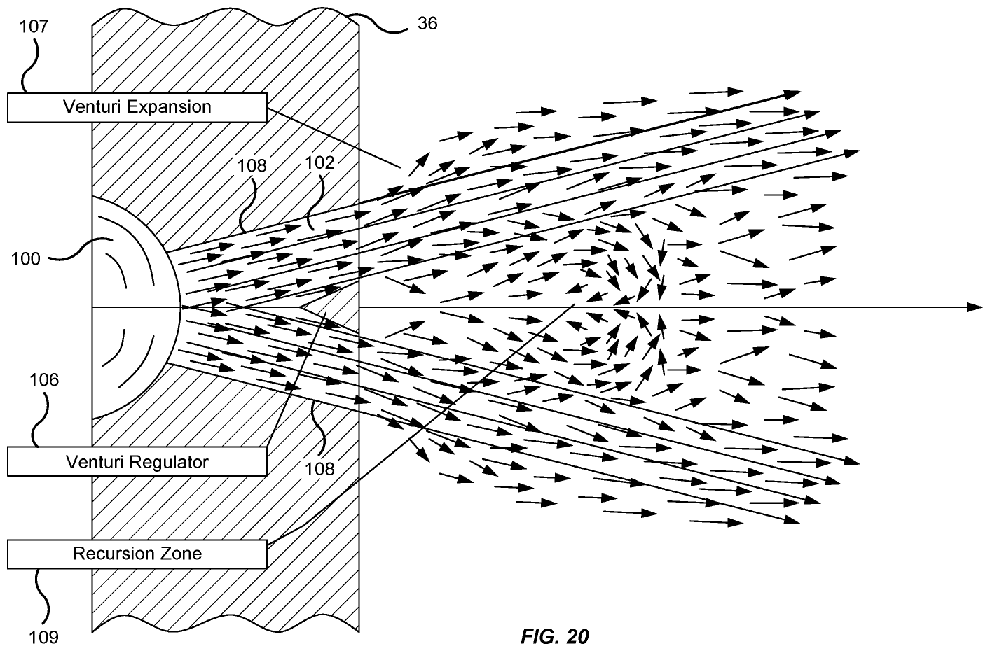

An example of the flow modifier processor element 36 is illustrated in FIGS. 13 and 14. The element 36 has a plurality of upstream, parabolic scalloped, dish-shaped openings 100 focusing the flow and increasing the velocity of the flow into venturi holes 102. In operation, the mixed first and second fluids flow into and through respective venturi holes 102. As shown in FIG. 20, each venturi hole 102 may have a venturi regulator 106 (FIG. 20) at its output. The optional venturi regulators 106 are not shown in FIG. 13 and may be hidden from view in FIG. 14. The openings 100 operate as individual collectors for receiving respective portions of the mixture of the first and second fluids. The venturi holes 102 are downstream from the parabolic dish-shaped openings 100.

In general, the flow modifier processor element 36 may have one or more pressure and velocity flow modifiers whose geometry and function are each that of a de Laval, venturi, or other suitable fluid dynamics modifier/expander. Venturi regulators 106, one of which is illustrated in FIG. 20, may be located in the exit of each such venturi 102. For each venturi 102, the flow regulator 106 causes the normally high velocity core to flow away from the center of the venturi output, promoting a venturi expansion 107.

As a result, the flow velocity near the conical wall 108 of the venturi 102 is increased. As the flow moves around the regulator 106 and accelerates, a shadowing pressure drop is created behind the regulator 106. This shadowing effect creates a recursion zone 109. High velocity fluid flow around the regulator 106 interacts with the flow from adjacent venturi (not illustrated in FIG. 20) while the first and second fluids in the recursion zone 109 are mixed together more completely.

In operation, the mixture of the first and second fluids may pass through a residence, reaction, or mixing chamber 34 (FIG. 2) and is introduced to the flow modifier processor element 36 where parabolic concave collectors 100 focus or direct portions of the fluid mixture into respective output holes and corresponding expanders 102. A venturi regulator 106, generally being conical in geometry, moves the higher velocity focused flow of the de Laval feature outwardly to the venturi walls 108 to bring wall flow to the same high velocity and create a recursion zone 109 behind the venturi regulator for further mixing action in the fluid flow. The fluid flow mixture may then be piped to a subsequent processing or storage stage downstream from the flow modifier processor element.

If desired, while imparting an angular change to the straightening flow within the angular (or conical) moving flow a recursion or eddy is induced, thus further inducing mixing as the viscous fluid is pressed with the remnants of the second fluid adding to the homogeneity of the final fluid flow.

The element 36 operates as a plurality of pressure and velocity flow modifiers, like de Laval nozzles, venturis, or other suitable fluid dynamic modifiers to provide additional mixing of the first and second fluids. Thus, the element 36 may be in the form of a disc with one or more concave inlet sides directing the multiple fluids mixture through a restriction, and then out into the main fluid flow line 25 through an expansion feature forming an expanding coherent homogeneous stream distributed evenly across an open area of the apparatus 12 whereby rapid expansion further enhances mixing to obtain homogeneity of the multiple fluids in the pipeline 10. As explained above, conical or expanding flow will induce recursion or eddy currents and thereby promote mixing.

If desired, the element 36 may have additional structural features, not shown in the drawings, which may advantageously affect flow characteristics. Such features may induce flow vector changes or induce locally high pressures which change fluid viscosity and improve mixing. The present disclosure should not be limited to the examples described herein except to the extent such examples are covered by the claims.

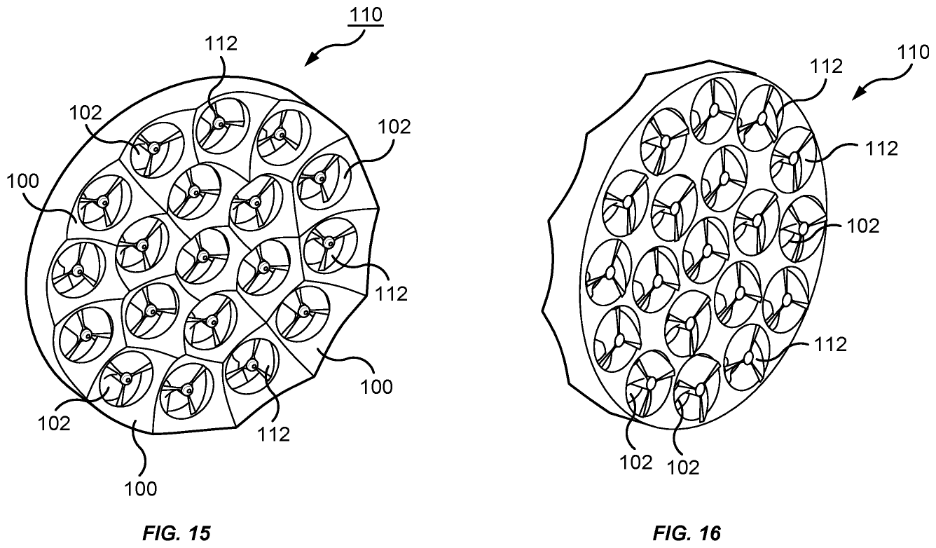

Another example of a flow modifier processer element 110 is illustrated in FIGS. 15 and 16. The element 110 is like the element 36 shown in FIGS. 13 and 14, except that the FIGS. 15 and 16 element 110 has additional swirler vanes 112 located within the downstream openings. The FIGS. 15 and 16 element 110 may be used in place of the FIGS. 2, 13, and 14 element 36, if desired. The additional swirler vanes 112 provide additional mixing of the first and second fluids where such additional mixing is desired. The additional swirler vanes 112 are located downstream of each concave entry location 100 into the flow modifier processor element 110 to further assist in the establishment of full contact mixing between the first and second fluids.

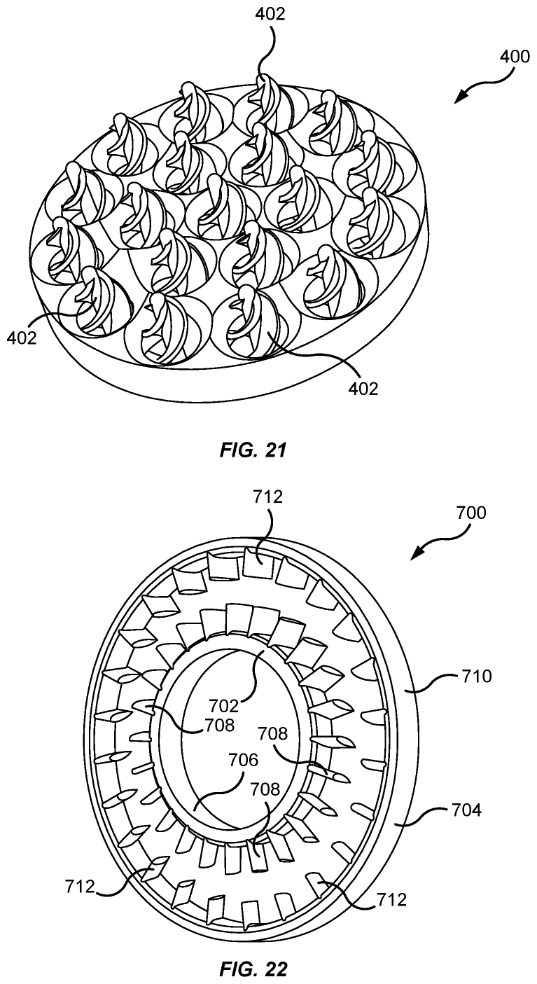

According to another embodiment of the present disclosure, a flow modifier processing element 400 (FIG. 21) may have swirlers 402 located upstream of corresponding parabolic receiving and downstream venturi elements. The swirlers 402 promote thorough mixing of the second fluid into the first fluid before the mixture enters the venturi elements for further fluid dynamic processing. If desired, mixing and turbulence creating elements described herein may be employed together in a variety of combinations, and certain such elements may be substituted for others to suitably accommodate flow conditions and mixing requirements.

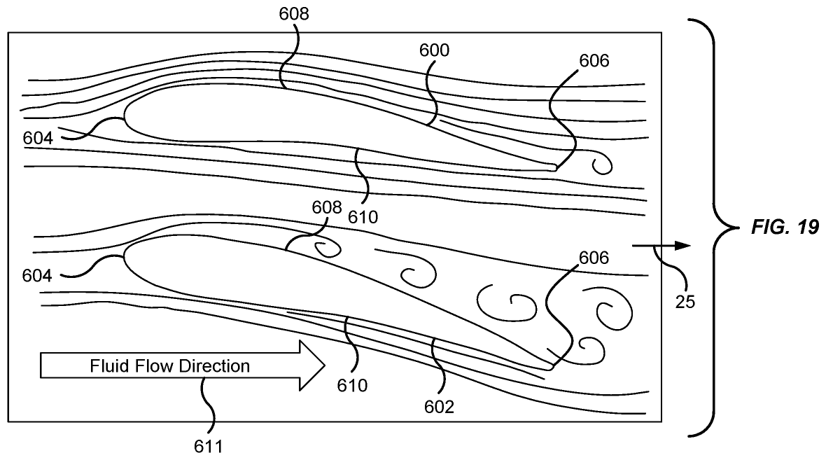

FIG. 19 is a schematic, cross-sectional view of swirler vanes 600, 602 constructed in accordance with one aspect of the present disclosure. The swirler vanes 600, 602 are shaped like airfoils (or hydrofoils). Each vane 600, 602 has a leading edge 604 and a trailing edge 606. The leading edge 604 is blunter than the trailing edge 606. The trailing edge 606 forms a sharper cross sectional angle than does the leading edge 604. As viewed in FIG. 19, the distance across a first surface 608, measured from the leading edge 604 to the trailing edge 606, is greater than the distance across a second surface 610, measured from the leading edge 604 to the trailing edge 606.

Each vane 600, 602 has an angle of attack relative to the fluid flow direction 611. The angle of attack is the angle between (1) a chord line from the leading edge 604 to the trailing edge 606 and (2) the fluid flow direction 611. In the illustrated example, the second vane 602 has a greater angle of attack than that of the first vane 600. Eddies and recursion of the fluid flow (which may be a flow of the first fluid) are formed on the first surface 608 and downstream from the trailing edge 604. The eddies and recursions may be increased or decreased by modifying the shape of the swirler vanes 600, 602 and by changing the angle of attack. FIG. 19 illustrates flow vectors across and downstream of the airfoil vanes 600, 602 which induce folding and recession along the leading and trailing edges 604, 606 and within the flow downstream from the swirler vanes 600, 602.

Any one or more of the swirler vanes discussed above, including the vanes 30, 60, 70 shown in FIGS. 4, 5, and 7-10, may have an airfoil-shaped configuration like the ones illustrated in FIG. 19. If desired, the second fluid may be introduced into the first fluid from perforations located on the second surface 610, near the trailing edge 606 of the swirler vanes. The airfoil-shaped configuration of the swirler vanes and the angle of attack of the swirler vanes may advantageously create eddies, recursion, and turbulence to promote thorough mixing of the second fluid into the first fluid.

Further, if desired, aero/fluid dynamic swirler vanes (like the ones illustrated in FIG. 19) may be employed in the residence chamber 34 to further improve mixing. These aerodynamic “wing” structures may be tuned to the fluid dynamics to induce major vortex flow by swirling action (depending, for example, on the angle of attack) and may also induce wake turbulence by creating minor vortices at the vane tips (depending, for example, on the configuration of the trailing edge 606 relative to other elements of the swirler structure). Vane tip wake vortices may be generated downstream of the trailing edges 606 by vortex circulation at each vane tip (trailing edge 606) outward, upward, and around the trailing edge 606. These vortices induce turbulence and thereby improve mixing with minimal energy requirements.

The cross-sectional open surface area of the assembly of vanes 30, 60, 70, or of any other equipment, within the mixing apparatus 12 should be in the range of from 90% to 140%, even more preferably from 100% to 130%, of the cross-sectional open area of the process pipe 18, 20 to ensure unrestricted, or at least satisfactory, flow through the mixing apparatus 12. If desired, a preferred cross-sectional open area for the mixing apparatus 12 may be determined by a fluid-dynamics numerical method or simulation uniquely associated with an intended use. To accommodate the desired difference in cross-sectional open surface area, the inner diameter of the mixing apparatus housing 26 should be greater than the inner diameter of the main pipeline portions 18, 20.

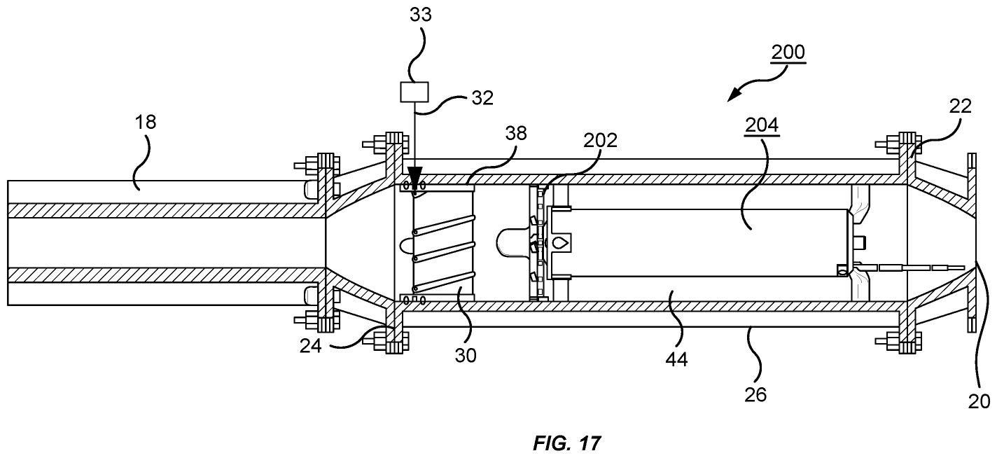

FIG. 17 shows an apparatus 200 for mixing, shearing, and homogenizing fluid within a pipeline 18, 20. In operation, a first fluid (which may be like the first fluid treated in the mixing apparatus 12) flows as a liquid in a laminar condition from left to right through the pipeline 18, 20. A second fluid (which may be like the second fluid introduced by the mixing apparatus 12) flows from a suitable source 33 and is mixed into the first fluid immediately after the first fluid is swirled by an assembly of swirling vanes 30.

The mixture of the first fluid and the second fluid then flows through a rotary shearing device 202 which shears material that is within the mixture into smaller pieces and improves mixing of the first and second fluids. The shearing may be performed by one or more rotary scissors (an example of a rotor/stator assembly). One or more of the scissors may be rotated by a suitable motor 204. The motor 204 may be hydraulic, pneumatic, or electric.

The casing length of the motor 204 provides a residence mixing chamber which may include one or more flow enhancing or mixing devices (modules) as described herein. In the embodiment illustrated in FIG. 17, the first fluid may be crude oil, the second fluid may be an inoculant or reactant for treating the crude oil, and the material that is sheared by the shearing device 202 may be globules of paraffin within the crude oil. The present disclosure is not limited, however, to the materials described herein except to the extent such materials are mentioned in the claims which follow.

If desired, the rotary shearing device 202 may be operated at a high rate of rotation so as to homogenize the severed pieces of paraffin within the mixture of fluids. The rotational speed of the rotary shearing device 202 may be variable. The speed of the device 202 may be variably timed to the flow rate of the first fluid such that the resultant size, or length, of the sheared fluid components are sheared to a programmed size.

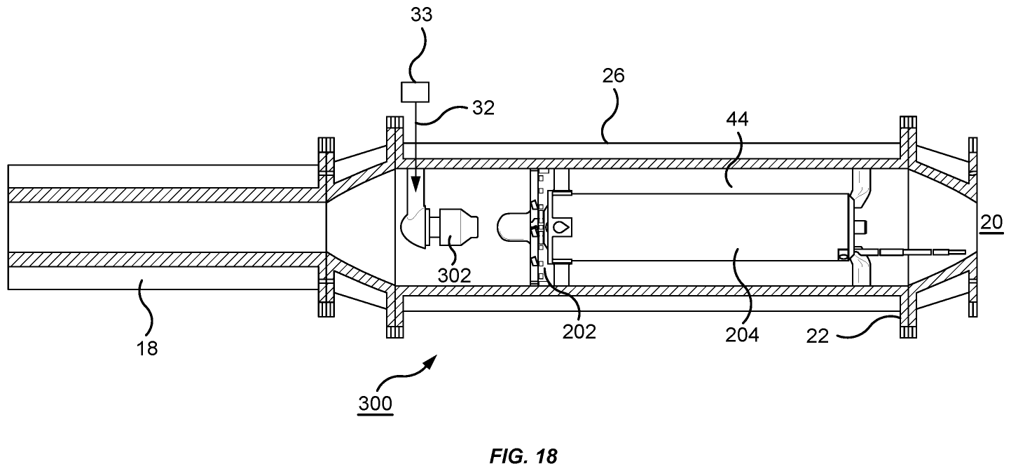

FIG. 18 shows another apparatus 300 for mixing, shearing, and homogenizing fluid within a pipeline 18, 20. The FIG. 18 apparatus 300 is essentially like the FIG. 17 apparatus 200 except that the FIG. 18 apparatus 300 has a multi-physics fluid delivery device 302 instead of the second fluids-delivering swirling vanes 30. The multi-physics fluid delivery device 302 may be employed to deliver the second fluid into the first fluid. In the embodiment illustrated in FIG. 18, the second fluid includes multiple fluids at least one of which may be a pressurized gas. If desired, the multi-physics fluid delivery device 302 may be one or more of the multi-physics fluid delivery devices shown and described in U.S. Pat. No. 9,982,643, issued May 29, 2018.

An example of a coaxial mixer 700 for use in the mixing-shearing apparatuses 200, 300 of FIGS. 17 and 18 is illustrated in FIG. 22. The coaxial mixer 700 has an inner vane ring 702 and a co-axial outer vane ring 704. The vane rings 702, 704 are aligned with each other and are essentially co-planar such that they both lie approximately or exactly within a common plane. The inner vane ring 702 has an inner cylindrical surface 706 and outwardly directed vanes 708. The outer vane ring 704 has an outer cylindrical surface 710 and inwardly directed vanes 712. The illustrated vanes 708, 712 may have airfoil-shaped configurations like the ones illustrated in FIG. 19, and may be constructed as winglets.

The diameter of the cylindrical surface 706 of the inner vane ring 702 is essentially the same as the outer diameter of the exterior surface of the motor 204 (FIGS. 17 and 18). The cylindrical surface 706 is fitted onto and connected to the exterior surface of the motor 204. The diameter of the cylindrical surface 710 of the outer vane ring 704 is essentially the same as the inner diameter of the system surrounding the motor (FIGS. 17 and 18). The outer cylindrical surface 710 is fitted onto and connected to the inner surface 44 of the system. During shearing and mixing operations, interaction between the inner vane ring 702 and the outer vane ring 704 promotes efficient and complete mixing of the second fluid into the first fluid.

The present disclosure should not be limited to features of the examples described herein, except to the extent such features are mentioned in the claims which follow. What is claimed is:

1. A method of mixing a second fluid into a first fluid with a high degree of surface contact between the first and second fluids, wherein the first fluid is a liquid, and wherein the method comprises:
flowing the first fluid into a mixing apparatus in a laminar condition;
swirling the first fluid within the mixing apparatus;
causing the second fluid to contact the first fluid; and
subsequently, causing a mixture of the first and second fluids to flow through a parabolic scalloped flow-focusing, dish-shaped device exiting into a venturi containing a venturi regulator, such that the first and second fluids are further mixed.

2. The method of claim 1, wherein the first fluid is a bulk fluid.

3. The method of claim 1, wherein the second fluid is an inoculant or reactant for treating the first fluid.

4. The method of claim 1, wherein the mixture of the first and second fluids contains more of the first fluid than the second fluid.

5. The method of claim 1, wherein the mixing apparatus is located within a fluid delivery system.

6. The method of claim 1, wherein the swirling of the first fluid is performed by radially arrayed aerodynamic vanes.

7. The method of claim 6, wherein the second fluid flows through openings in upstream surfaces of the aerodynamic vanes to form a film on the vanes to promote the mixing of the second fluid into the first fluid.

8. The method of claim 6, wherein the second fluid flows through openings at the leading or trailing edges of the vanes.

9. An apparatus for mixing a second fluid into a first fluid with a high degree of surface contact between the first and second fluids, wherein the first fluid is a liquid, and wherein the apparatus comprises:
an inlet for flowing the first fluid into the mixing apparatus in a laminar condition;
a swirling device for swirling the first fluid within the mixing apparatus;
flow passages within the swirling device for causing the second fluid to come into contact with the first fluid; and
a parabolic scalloped, dish-shaped device with a regulated venturi exit, downstream of the swirling device, for causing the first and second fluids to be further mixed.

10. The apparatus of claim 9, wherein the apparatus is configured to operate within a fluid delivery system.

11. The apparatus of claim 9, wherein the swirling device includes radially arrayed aerodynamic vanes.

12. The apparatus of claim 11, wherein the vanes have upstream surfaces, and openings in the upstream surfaces, for causing the second fluid to form films on the upstream surfaces of the vanes thus providing full surface area contact.

13. The apparatus of claim 12, wherein the openings are spaced apart from each other and diagonally aligned such that each opening is aligned with a different line of flow of the first fluid across the upstream surfaces of the vanes, to improve distribution of the second fluid into the first fluid.

14. The apparatus of claim 11, wherein the vanes include leading and trailing edges and openings for the second fluid at the leading or trailing edges.

15. The apparatus of claim 9, further comprising one or more intermediate swirling plate located between the swirling device and the parabolic scalloped, dish-shaped device.

16. A method of mixing a second fluid into a first fluid with a high degree of surface contact between the first and second fluids, wherein the first fluid is a liquid, and wherein the method comprises:
flowing the first fluid into a mixing apparatus in a laminar condition;
causing the second fluid to full surface contact the first fluid;
subsequently, rotatably shearing material within a mixture of the first and second fluids; and
performing shear rotation with variable timing to provide a programmable and precise laminar ligament size or length.

17. The method of claim 16, wherein the second fluid is an inoculant or reactant for treating the first fluid.

18. The method of claim 16, wherein the second fluid is introduced into the first fluid by an assembly of aerodynamic swirling vanes.

19. The method of claim 16, wherein the second fluid includes a pressurized gas and at least one other fluid, and the second fluid is introduced into the first fluid by a multi-physics fluid delivery device.

20. An apparatus for mixing a second fluid into a first fluid, wherein the first fluid is a liquid, and wherein the apparatus comprises:
an inlet for flowing the first fluid into the apparatus in a laminar condition;
flow passages for causing the second fluid to come into contact with the first fluid; and
a rotatable shearing device for shearing material within a mixture of the first and second fluids.

21. The apparatus of claim 20, wherein the shearing device includes a variable speed rotatable scissor for shearing the material within the mixture of the first and second fluids to a programmed size or length.

22. The apparatus of claim 21, further comprising a motor for rotating the scissor, the motor being located downstream of the flow passages for causing the second fluid to come into contact with the first fluid.
